(19) United States
(12) Patent Application Publication
(10) Pub. No.: US 2006/0026330 A1
(43) Pub. Date: Feb. 2, 2006

(54) Bus arbitration system that achieves power savings based on selective clock control

(76) Inventors: Doo-youll Yi, Gyeonggi-do (KR); Hae-jin Song, Gyeonggi-do (KR)

Correspondence Address: MYERS BIGEL SIBLEY & SAJOVEC, PO BOX 37428, RALEIGH, NC, 27627, US

(21) Appl. No.: 11/109,556

(22) Filed: Apr. 19, 2005

(30) Foreign Application Priority Data
Jul. 28, 2004 (KR) 2004-59116

(51) Int. Cl. G06F 13/36

(52) U.S. Cl. 710/309

(57) ABSTRACT

A bus arbitration system includes a bus master, a bus arbitration circuit and a clock signal changing circuit. The bus master is configured to enter a power saving mode of operation in response to a disabled first master clock signal. The bus arbitration circuit is configured to issue a bus access grant to the first bus master in response to a request for bus access issued by the first bus master. The clock signal changing circuit is electrically coupled to the first bus master and the bus arbitration circuit. The clock signal changing circuit is configured to generate the disabled first master clock signal in response to the request for bus access. The clock signal changing circuit is further configured to convert the disabled first master clock signal to an enabled first master clock signal in response to the bus access grant.

### REFERENCE TO PRIORITY APPLICATION

This application claims priority to Korean Application Serial No. 2004-59116, filed Jul. 28, 2004, the disclosure of which is hereby incorporated herein by reference.

### FIELD OF THE INVENTION

The present invention relates to integrated circuit devices and systems and, more particularly, to integrated circuit devices and systems that communicate with buses.

### BACKGROUND OF THE INVENTION

FIG. 1 is a block diagram of a conventional bus arbitration system 100. The bus arbitration system 100 includes a bus 140, first and second slaves 150 and 160, first and second bus masters 120 and 130 that occupy the bus 140 to transmit/receive data to/from the first and second slaves 150 and 160, respectively, and an arbiter 110 that arbitrates use of the bus 140 between the first and second bus masters 120 and 130. The operation of the bus arbitration system 100 will now be described with reference to the timing diagram of FIG. 2.

In general, a bus is shared by a plurality of bus masters in a system-on-chip (SOC). Therefore, there is a case where at least two bus masters desire to occupy the bus at the same time and, thus, there may be bus masters that make a request to receive a grant for occupying the bus but do not receive the grant. The bus masters that are not given the grant for bus access will continue to make the request until they are granted.

Referring to FIG. 1, when the first and second bus masters 120 and 130 make a request to occupy the bus 140 to the arbiter 110, the arbiter 110 provides only one of them with an occupancy right for the bus 140 according to priority determined using a fixed priority or round robin scheme. For instance, as shown in FIG. 2, when both the first and second bus masters 120 and 130 activate bus request signals REQM1 and REQM2 and send them to the arbiter 110, respectively, the arbiter 110 first activates a grant signal GNTM1 and transmits it to the first bus master 120 so as to provide the first bus master 120 with a grant for use of the bus 140 according to predetermined priority. After the first bus master 120 completes use of the bus 140, the arbiter 110 activates a grant signal GNTM2 and transmits it to the second bus master 130 to provide the second bus master 130 with a grant for use of the bus 140. As shown in FIG. 2, it is assumed that a reference clock signal HCLK, which is used as a synchronization signal when the arbiter 110 activates the grant signals GNTM1 and GNTM2, and clock signals CLKM1 and CLKM2, which are used as synchronization signals when the first and second bus masters 120 and 130 transmit the bus request signals REQM1 and REQM2, respectively, are synchronized with one another and have the same pulse duration.

After making the requests for the bus 140, the bus masters 120 and 130 stand by until they receive a grant for use of the bus 140 without canceling the requests. The highlighted time intervals (A), (B), and (C) of FIG. 2 reveal that while the bus masters 120 and 130 stand by without canceling their requests, that is, until the grant signals GNTM1 and GNTM2 are activated after the bus request signals REQM1 and REQM2 are activated, the clock signals CLKM1 and CLKM2 used by the bus masters 120 and 130 are kept. Accordingly, until the bus masters 120 and 130 make the request for the bus 140 and are given an occupancy right for the bus 140, their internal circuits to which the clock signals CLKM1 and CLKM2 are input experience significant power consumption due to frequent switching caused by the pulse transitions of the clock signals CLKM1 and CLKM2. The internal circuits of the bus masters 120 and 130 may be Complementary Metal-Oxide-Semiconductor (CMOS) logic circuits or Transistor-Transistor Logic (TTLs) circuits. However, a lot of the power consumption caused by switching of the internal circuits in response to the clock signals CLKM1 and CLKM2 is unavoidable until the bus masters 120 and 130 are given a right for use of the bus 140 after making the request, irrespective of the types of internal circuits.

To solve this problem, U.S. Pat. No. 6,560,712 discloses a method of reducing power consumption in the internal circuits of bus masters. Specifically, when one of the bus masters is given a grant for use of a bus, a processor core enters a low-power state (i.e., a standby mode), until the bus master occupies the bus and completes data transmission. In the standby mode, the state of the processor core right before entering the standby mode is maintained and operations within the processor core are suspended. Therefore, although use of this method brings about a reduction in power consumption, because the operation of the processor core is suspended, the performance of the system is degraded.

### SUMMARY OF THE INVENTION

Bus arbitration systems according to embodiments of the invention include a first bus master responsive to a first master clock signal (e.g., CLKM1). The first bus master is configured to operate normally when the first master clock signal is active and also enter a power saving mode of operation when the first master clock signal is disabled (i.e., inactive). A clock signal changing circuit is also provided. The clock signal changing circuit is configured to generate the disabled first master clock signal in response to a request for bus access (e.g., REQM1) issued by the first bus master. The bus arbitration system also includes an arbitration circuit. This arbitration circuit is configured to issue a bus access grant (e.g., GNTM1) to the bus master in response to the request for bus access. According to aspects of these embodiments, the clock signal changing circuit is responsive to the bus access grant and the clock signal changing circuit is further configured to convert the disabled first master clock signal to an enabled first master clock signal in response to the bus access grant.

Still further embodiments of the invention include a plurality of bus masters that are responsive to corresponding master clock signals, which are generated by the clock signal changing circuit. This clock signal changing circuit may receive a plurality of clock signals, which are synchronized to each other, from a clock signal generating unit.

### BRIEF DESCRIPTION OF THE DRAWINGS

FIG. 1 is a block diagram of a conventional bus arbitration system.

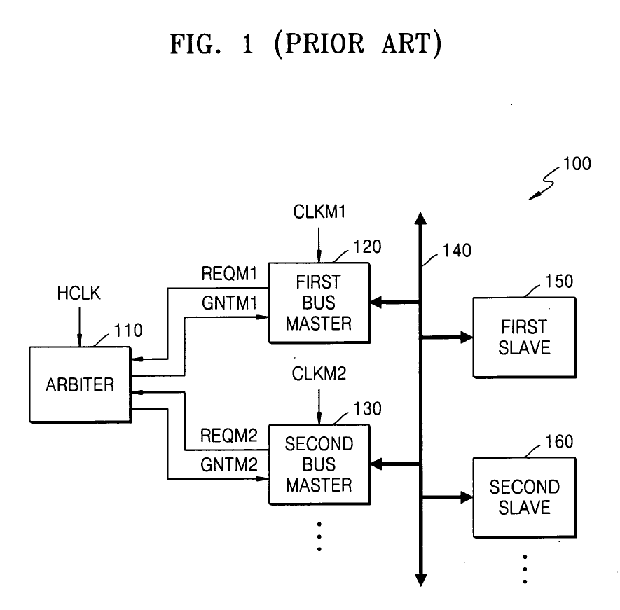

FIG. 2 is a timing diagram that illustrates operation of the bus arbitration system of FIG. 1.

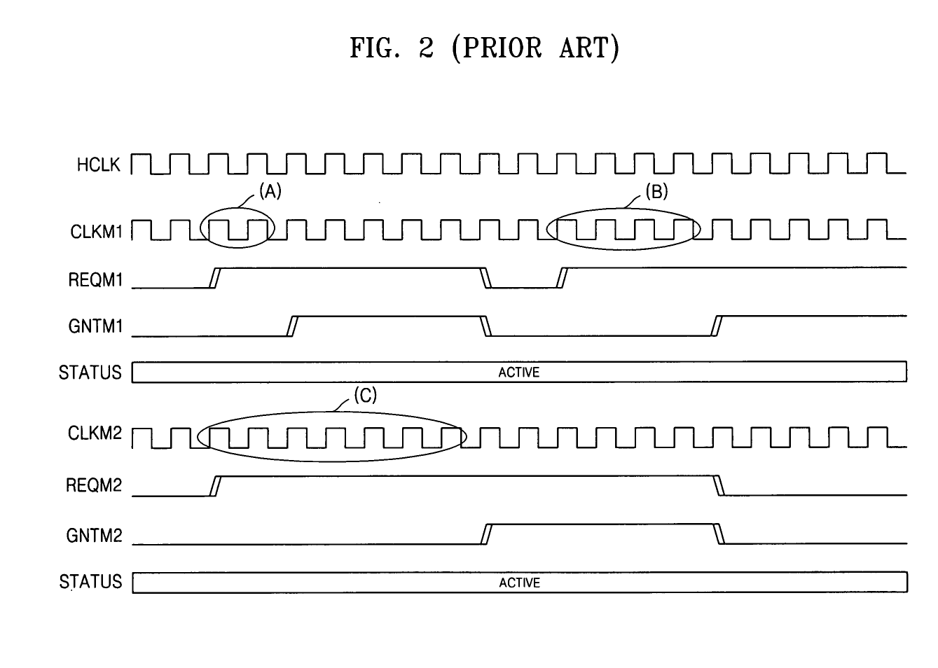

FIG. 3 is a block diagram of a bus arbitration system according to an embodiment of the present invention.

FIG. 4 is a timing diagram that illustrates operation of the bus arbitration system of FIG. 3.

FIG. 5 is a flow diagram of steps that illustrate operation of the bus arbitration circuit of FIG. 3.

### DETAILED DESCRIPTION OF EMBODIMENTS OF THE INVENTION

The present invention now will be described more fully herein with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to like elements throughout and signal lines and signals thereon may be referred to by the same reference characters. Signals may also be synchronized and/or undergo minor boolean operations (e.g., inversion) without being considered different signals.

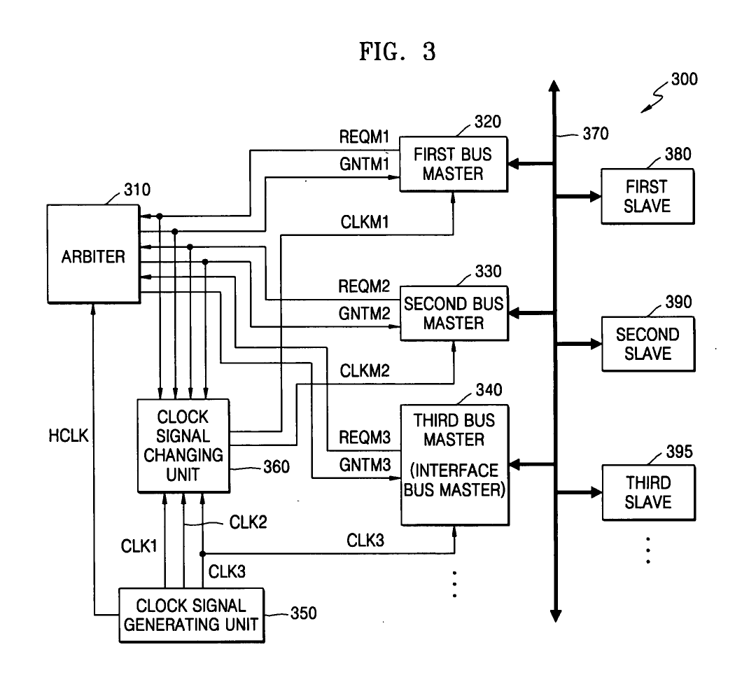

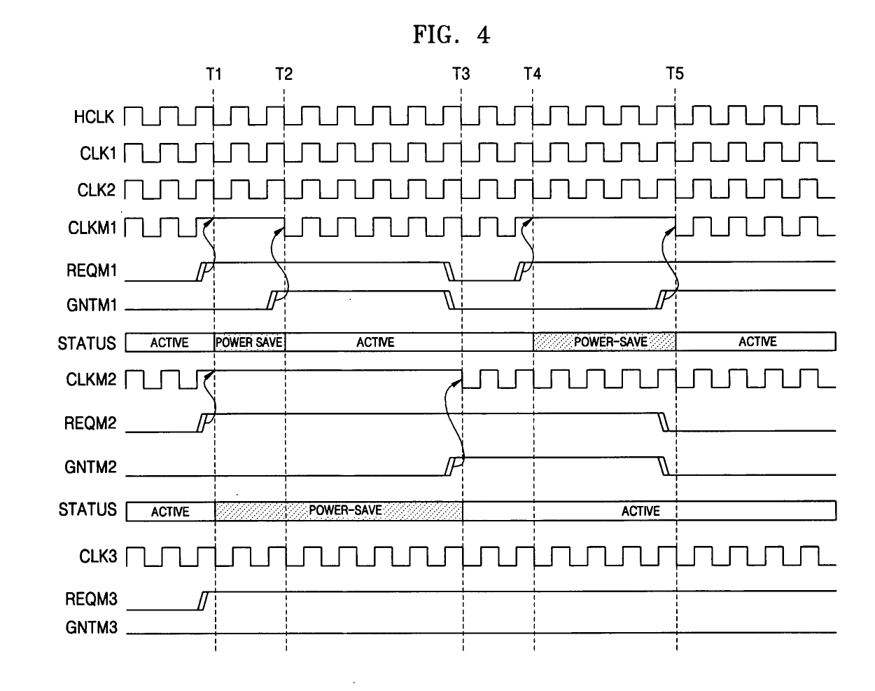

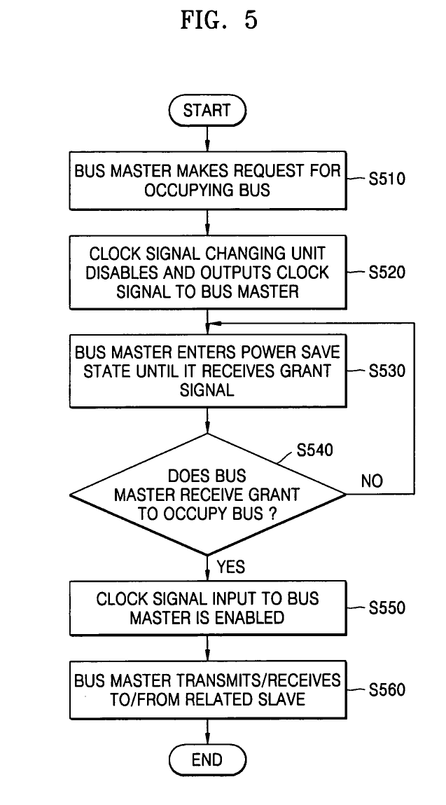

FIG. 3 is a block diagram of a bus arbitration system 300 according to an embodiment of the present invention. The bus arbitration system 300 includes an arbiter 310, first and second bus masters 320 and 330, an interface bus master 340, a clock signal generating unit 350, a clock signal changing unit 360, a bus 370, and a plurality of slaves 380, 390 and 395. The operation of the bus arbitration system 300 will now be described with reference to FIGS. 4 and 5.

The clock signal generating unit 350 generates source clock signals CLK1 and CLK2 to be used by the first and second bus maters 320 and 330, a source clock signal CLK3 to be used by the interface bus master 340, and a source clock signal HCLK to be used by the arbiter 310. In this embodiment, it is assumed that the source clock signals CLK1 through CLK3 and HCLK are synchronized with one another and have the same pulse periods. However, the present invention is not limited to the above description. For instance, the above signals may have different pulse periods. The source clock signals CLK1 through CLK3 and HCLK are always enabled.

The bus masters 320 and 330 transmit bus request signals REQM1 and REQM2 in synchronization with the master clock signals CLKM1 and CLKM2, respectively. In response to the bus request signals REQM1 and REQM2, the arbiter 310 generates grant signals GNTM1 and GNTM2 and transmits them to the bus masters 320 and 330, respectively, and the clock signal changing unit 360. When the grant signals GNTM1 and GNTM2 are activated, the bus masters 320 and 330 occupy the bus 370, and transmit data to related ones of the slaves 380 through 395 and perform write operations, or receive data from related ones of the slaves 380 through 395 and perform their own operations. The slaves 380 through 395 may be information storage media such as a memory.

The arbiter 310 computes priorities of use of the bus 370 using a predetermined method and determines the highest priority in response to the bus request signals REQM1 and REQM2 transmitted from the bus masters 320 and 330, respectively. As described above, the highest priority may be determined using fixed priority, round robin, or a combination scheme thereof. Since computing of priority is not the subject matter of the present invention, a detailed description thereof will be omitted. When the highest priority is determined, the arbiter 310 transmits the grant signals GNTM1 and GNTM2 activated at the first or second logic state to the bus masters 320 and 330, respectively, and the clock signal changing unit 360. As previously mentioned, the arbiter 310 operates using the source clock signal HCLK, and transmits the activated grant signals GNTM1 and GNTM2 in synchronization with the source clock signal HCLK.

The clock signal changing unit 360 disables the source clock signal CLK1 (or CLK2) and outputs it to the first bus master 320 (or 330), in response to the bus request signal REQM1 (or REQM2) and the grant signal GNTM1 (or GNTM2) related to the bus master 320 (or 330). In other words, the clock signal changing unit 360 disables the source clock signal CLK1 (or CLK2) to obtain the master clock signal CLKM1 (or CLKM2) and outputs the master clock signal CLKM1 (or CLKM2) to the bus master 320 (or 330) until the grant signal GNTM1 (or GNTM2) is activated and transmitted to the bus master 320 (or 330).

The first and second bus masters 320 and 330 operate using the master clock signals CLKM1 and CLKM2 obtained by disabling the source clock signals CLK1 and CLK2 in the power save state. In detail, the first bus master 320 operates via an interface to only the bus 370, and the second bus master 330 operates via an interface to not only the bus 370 but also to an external logic (not shown). Even when a clock signal used during interfacing the external logic is disabled in the power save state, the operation of the second bus master 330 is not entirely affected by the disabling of the clock signal. The first bus master 320 cannot perform its operation when it does not occupy the bus 370. An ARM core or a General Direct Memory Access (GDMA) block may be used as the first bus master 320. A Peripheral Component Interconnect (PCI) block of a Local Area Network (LAN) card that can interface with a computer processor may be used as the second bus master 330.

However, there may be a bus master that does not operate using the master clock signal CLKM1 or CLKM2. For instance, there is a third bus master 340 that operates via an interface to the bus 370 or another external logic but the operation of the bus master during interfacing to the external logic is affected when a clock signal required is disabled in the power save state. That is, disabling of the clock signal results in data loss or disconnection of the interface in the bus master. The third bus master 340 may be a Medium Access Control (MAC) block of the LAN card that interfaces to a Base Band Processor (BBP) block. FIG. 3 illustrates the interface bus master 340 as an example of a bus master that does not receive a disabled clock (e.g., CLK3) when a request for bus access (i.e., REQM3) is pending with the arbiter 310.

In this embodiment, the bus arbitration system 300 uses two types of bus masters, i.e., the bus masters 320 and 330 and the interface bus master 340. The bus masters 320 and 330, which are affected by disabling of master clock signals, operate via an interface to the bus 370 in response to the disabled master clock signals CLKM1 and CLKM2. The interface bus master 340, which is not affected by disabling of a clock signal during an interface to an external logic, operates in response to the source clock signal CLK3. That is, the interface bus master 340 operates in response to the source clock signal CLK3 generated by the clock signal generating unit 350, rather than the master clock signals CLKM1 and CLKM2 generated by the clock signal changing unit 360, and thus can perform an interface to an external logic without disabling the source clock signal CLK3.

The operation of the bus arbitration system 300 will now be described in detail with reference to FIGS. 4 and 5. Referring to FIG. 5, the first and second bus masters 320 and 330 make requests for occupying the bus 370 at the same time by activating the bus request signals REQM1 and REQM2 at an instance T1 of time shown in FIG. 4 (S510). The master clock signals CLKM1 and CLKM2 input to the bus masters 320 and 330 are disabled right after the requests are made (S520). In this case, the master clock signals CLKM1 and CLKM2 input to the first and second bus masters 320 and 330 are disabled, and thus, the first and second bus masters 320 and 330 enter the power save state until the grant signals GNTM1 and GNTM2 are activated and transmitted to the first and second bus masters 320 and 330, respectively (S530).

At an instance T2 of time, the first bus master 320 is provided with a grant to occupy the bus 370 earlier than the second bus master 330 through arbitration of the arbiter 310 (S540). Then, the master clock signal CLKM1 input to the bus master 320 is enabled (S550). Since the bus master 330 that also made the request for occupying the bus 370 does not receive a grant therefor, the master clock signal CLKM2 is kept disabled and the power save state of the second bus master 330 is maintained. Thus, although the second bus master 330 continues activating and outputting the bus request signal REQM2, the second bus master 330 can be on standby without degrading its operation until it receives the grant.

At an instance T3 of time, the bus master 320 completes transmission/receiving of data to/from a related slave while occupying the bus 370, and makes the bus request signal REQM1 be at the first logic state (S560). As a result, the occupancy right for the bus 370 given to the first bus master 320 is canceled, and then, the second bus master 330 is provided with a grant for occupying the bus 370 according to a bus arbitration algorithm of the arbiter 310. After the grant signal GNTM2 is activated, the disabled master clock signal CLKM2 input to the second bus master 330 becomes enabled.

At an instance T4 of time, the first bus master 320 makes a request for the bus 370 again but it cannot receive a grant for use of the bus 370 since the second bus master 330 has yet to cancel the occupancy right for the bus 370. Thus, the first bus master 320 makes a request for the bus 370 again and enters the power save state in response to the disabled master clock signal CLKM1 until the grant signal GNTM1 is activated and transmitted to it in response to the request.

At an instance T5 of time, the second bus master 330 completes occupying the bus 370 and cancels the occupancy right for the bus 370, and thus, the first bus master 320 is again given a grant for the occupancy right of the bus 370 according to the priority. In this case, the master clock signal CLKM1 is enabled again and the first bus master 320 transmits/receives data to/from a related slave (S560).

On the other hand, the interface bus master 340 receives the source clock signal CLK3 directly from the clock signal generating unit 350 and transmits a bus request signal REQM3 in synchronization with the source clock signal CLK3 to the arbiter 310. That is, the clock signal CLK3 is generated by the clock signal generating unit 350 while not being disabled. When the arbiter 310 transmits a grant signal GNTM3 to the interface bus master 340 in response to the bus request signal REQM3, the interface bus master 340 performs an interface to an external logic.

As described above, the bus arbitration system 300 according to the present invention further includes the clock signal changing unit 360 controlled by the bus request signals REQM1 and REQM2 and the grant signals GNTM1 and GNTM2, generates the master clock signals CLKM1 and CLKM2 to be disabled until the first and second bus masters 320 and 330 make requests for the bus 370 and receive grants for occupying the bus 370, and inputs them to the bus masters 320 and 330, respectively. When the grant for the bus 370 is given to the bus mater 320 (or 330) and the master clock signal CLKM1 (or CLKM2) is enabled, the bus master 320 (or 330) can occupy the bus 370 and transmits/receives data to/from a related slave. In the bus arbitration system 300, the source clock signal CLK3 is always kept enabled so as to prevent the inner circuit of the interface bus master 340 from malfunctioning when the interface bus master 340 performs an interface to an external logic.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A bus arbitration system, comprising:
a first bus master configured to enter a power saving mode of operation in response to a disabled first master clock signal; and
a clock signal changing circuit configured to generate the disabled first master clock signal in response to a request for bus access issued by said first bus master.

2. The bus arbitration system of claim 1, further comprising:
an arbitration circuit configured to issue a bus access grant to said first bus master in response to the request for bus access.

3. The bus arbitration system of claim 2, wherein said clock signal changing circuit is responsive to the bus access grant; and wherein said clock signal changing circuit is configured to convert the disabled first master clock signal to an enabled first master clock signal in response to the bus access grant.

4. The bus arbitration system of claim 3, further comprising a clock signal generating circuit configured to generate a plurality of clock signals that are synchronized to each other; and wherein said arbitration circuit is responsive to a first one of the plurality of clock signals and said clock signal changing circuit is responsive to a second one of the plurality of clock signals.

5. The bus arbitration system of claim 4, further comprising a second bus master configured to respond to a third one of the plurality of clock signals.

6. A bus arbitration system, comprising:
a first bus master configured to enter a power saving mode of operation in response to a disabled first master clock signal;
a bus arbitration circuit configured to issue a bus access grant to said first bus master in response to a request for bus access issued by said first bus master; and
a clock signal changing circuit electrically coupled to said first bus master and said bus arbitration circuit, said clock signal changing circuit configured to generate the disabled first master clock signal in response to the request for bus access and further configured to convert the disabled first master clock signal to an enabled first master clock signal in response to the bus access grant.

7. The bus arbitration system of claim 6, further comprising a clock signal generating circuit configured to generate a plurality of clock signals that are synchronized to each other; and wherein said bus arbitration circuit is responsive to a first one of the plurality of clock signals and said clock signal changing circuit is responsive to a second one of the plurality of clock signals.

8. A bus arbitration system comprising:
a plurality of bus masters, each transmitting a bus request signal using a clock signal, receiving a grant signal made in the bus request signal, and occupying a bus, transmitting data to a related slave, and receiving data from the related slave when the grant signal is activated; and
an arbiter computing priority using a predetermined method and transmitting the activated grant signal to a bus master with highest priority in response to bus request signals transmitted from the plurality of bus masters,
wherein the clock signal is disabled until the bus request signal is activated and the grant signal is activated in response to the activated bus request signal.

9. The bus arbitration system of claim 8, further comprising:
a clock signal generating unit generating source clock signals; and
a clock signal changing unit disabling one of the source clock signals and outputting the disabled source clock signal as a clock signal to a corresponding bus master of the plurality of bus masters, which transmits the activated bus request signal, until the grant signal is activated and transmitted, using a related bus request signal of the bus request signals and a related grant signal of the grant signals.

10. The bus arbitration system of claim 9, wherein when the clock signal changing unit disables one of the source clock signals, a logic state of the disabled clock signal is fixed at one of a first logic state and a second logic state.

11. The bus arbitration system of claim 9, wherein the source clock signals are always kept enabled.

12. The bus arbitration system of claim 11, further comprising an interface bus master performing an interface to an external logic using one of the source clock signals without disabling the source clock signal used.

13. The bus arbitration system of claim 12, wherein the source clock signals are synchronized with one another.

14. The bus arbitration system of claim 13, wherein the arbiter operates using one of the source clock signals and transmits the activated grant signal in synchronization with the source clock signal used.

15. A bus arbitration method comprising:
each of a plurality of bus masters transmitting a bus request signal using a clock signal;
an arbiter computing priority for use of a bus using a predetermined method and transmitting an activated grant signal to a bus master with highest priority in response to bus request signals transmitted from the plurality of bus masters;
disabling and outputting source clock signals as the corresponding clock signal to the corresponding bus master of the bus masters, which transmits the activated bus request signal, until the related grant signals are activated and transmitted to the other bus master, using the corresponding bus request signal and grant signal;
the bus master, which receives the activated grant signal, occupying the bus, transmitting data to a related slave, and receiving data from the related slave.

16. The bus arbitration method of claim 15, further comprising generating the source clock signals,
wherein a logic state of the disabled clock signal is fixed at one of a first logic state and a second logic state.

17. The bus arbitration method of claim 16, wherein the source clock signals are always kept enabled.

18. The bus arbitration method of claim 17, further comprising performing an interface between a bus master using one of the source clock signals and an external logic without disabling the source clock signal used.

19. The bus arbitration method of claim 18, wherein the source clock signals are synchronized with one another.

20. The bus arbitration method of claim 19, wherein the arbiter operates using one of the source clock signals and transmits the activated grant signal in synchronization with the source clock signal used.
